(19) United States
(12) Patent Application Publication
(10) Pub. No.: US 2025/0356716 A1
(43) Pub. Date: Nov. 20, 2025

(54) MEDIUM PROCESSING APPARATUS AND STORAGE METHOD

(71) Applicant: GLORY LTD., Hyogo (JP)

(72) Inventor: Shimpei NISHIDA, Hyogo (JP)

(21) Appl. No.: 18/668,331

(22) Filed: May 20, 2024

(51) Int. Cl. G07D 7/202; E05G 1/06; G06Q 20/04; G06Q 20/42; G06V 30/224; G06V 30/42; G07D 11/13; G07D 11/14; G07D 11/18

(52) U.S. Cl. CPC G07D 7/202; G06Q 20/042; G06Q 20/42; G06V 30/2253; G06V 30/42; G07D 11/13; G07D 11/14; G07D 11/18; E05G 1/06; G07D 2207/00; G07D 2211/00

(57) ABSTRACT

Provided is a medium processing apparatus that processes a valuable medium comprising a check and a banknote. The medium processing apparatus includes: an internal storage that is disposed inside a safe and stores the valuable medium; an external storage that is disposed outside the safe and stores the valuable medium; a recognition circuitry that acquires recognition information from the valuable medium having been received by the medium processing apparatus and recognizes the valuable medium based on the recognition information; and a controller that recognizes the valuable medium based on the recognition information and performs control such that the valuable medium having been recognized as the check is stored in the external storage.

### TECHNICAL FIELD

The present disclosure relates to a medium processing apparatus capable of receiving a valuable medium and performing predetermined processing on the valuable medium, and a storage method of the medium processing apparatus.

### BACKGROUND ART

A medium processing apparatus capable of automatically receiving and recognizing a plurality of kinds of valuable media, for example, banknotes and checks and performing predetermined processing according to the kinds of the valuable media has been developed.

### SUMMARY

A medium processing apparatus according to an aspect of the present disclosure processes a valuable medium comprising a check and a banknote. The medium processing apparatus comprises: an internal storage that is disposed inside a safe and stores the valuable medium; an external storage that is disposed outside the safe and stores the valuable medium; a recognition circuitry that acquires recognition information from the valuable medium having been received by the medium processing apparatus and recognizes the valuable medium based on the recognition information; and a controller that recognizes the valuable medium based on the recognition information and performs control such that the valuable medium having been recognized as the check is stored in the external storage.

### BRIEF DESCRIPTION OF DRAWINGS

FIG. 1 is an external perspective view of a medium processing apparatus;

FIG. 2 is a schematic cross-sectional view of the medium processing apparatus in a front-rear direction;

FIG. 3 illustrates an external appearance of the medium processing apparatus when an external cassette is attached to an attachment unit;

FIG. 4 is a functional block diagram provided for describing a functional configuration of the medium processing apparatus;

FIG. 5 is a flowchart provided for describing a first example of reception processing of the medium processing apparatus;

FIG. 6 is a flowchart provided for describing a second example of the reception processing of the medium processing apparatus;

FIG. 7 illustrates a relationship between the medium processing apparatus and an external apparatus in the second example of the reception processing; and

FIG. 8 illustrates an example of a hardware configuration of the medium processing apparatus as a computer.

### DESCRIPTION OF EMBODIMENTS

A Check, unlike a banknote, is not reutilized. In addition, when a transaction involving a given check has been completed, the value comprised by the check is lost. It is desirable for a medium processing apparatus to be able to efficiently collect a check for which a transaction has been completed.

An object of the present disclosure is to provide a medium processing apparatus configured to handle a plurality of kinds of valuable media and capable of gathering checks, for which transactions have been completed, in one place.

A medium processing apparatus according to an aspect of the present disclosure processes a valuable medium comprising a check and a banknote. The medium processing apparatus comprises: an internal storage that is disposed inside a safe and stores the valuable medium; an external storage that is disposed outside the safe and stores the valuable medium; a recognition circuitry that acquires recognition information from the valuable medium having been received by the medium processing apparatus and recognizes the valuable medium based on the recognition information; and a controller that recognizes the valuable medium based on the recognition information and performs control such that the valuable medium having been recognized as the check is stored in the external storage.

With such a configuration, the medium processing apparatus capable of handling a check and a banknote can store a check in the external storage. In comparison with the internal storage disposed inside a safe 13, the external storage comprises an advantage that it is easier for the manager of a medium processing apparatus 1 to collect a stored valuable medium. By configuring the external storage as the storage destination for a check in the medium processing apparatus configured to handle a check and a banknote as described above, it is possible to significantly reduce the labor of the manager when collecting a check.

In the medium processing apparatus according to an aspect of the present disclosure, the recognition circuitry may comprise an image sensor, which acquires an image of the valuable medium, and a magnetic sensor, which acquires magnetic ink character recognition (MICR) information of the check, where the image and the MICR information are the recognition information, and the controller may perform control based on at least one of the image and/or the MICR information such that the check, for which at least one of the image and/or the MICR information has been acquired, is stored in the external storage.

Such a configuration makes it possible to store a used check, for which an image and MICR information have been acquired, in the external storage. This facilitates collecting a used check.

In the medium processing apparatus according to an aspect of the present disclosure, the controller may perform control such that the at least one of the image and/or the MICR information, which has been acquired from the check, is transmitted to an external apparatus that approves a transaction involving the check.

Such a configuration allows the external apparatus to approve a check that has been received by the medium processing apparatus.

The medium processing apparatus according to an aspect of the present disclosure may further comprise a notification unit. In a case where the transaction involving the check has not been approved by the external apparatus, the controller may control the notification unit such that the notification unit notifies that the transaction has not been approved.

With such a configuration, in a case where a transaction involving a received check has not been approved, it is possible to expect that appropriate measures are taken by a person who has been notified (for example, the manager of the medium processing apparatus 1, or the like).

The medium processing apparatus according to an aspect of the present disclosure may further comprise a temporary storage that temporarily stores the valuable medium having been received by the medium processing apparatus before the valuable medium having been received by the medium processing apparatus is stored in the internal storage or the external storage. In a case where the valuable medium having been recognized as the check is temporarily stored in the temporary storage and then the transaction involving the check is approved by the external apparatus, the controller may perform control such that the valuable medium having been stored in the temporary storage is stored in the external storage.

With such a configuration, a check that is deemed to have lost its value due to approval of a transaction is stored in the external storage. Thus, the operation to open the safe frequently to take out checks from the internal storage in order to clear the fullness of the internal storage, which is caused by storing checks in the internal storage to fully fill the internal storage, can be reduced. Further, a check stored in the external storage can be easily collected from outside of the medium processing apparatus.

The medium processing apparatus according to an aspect of the present disclosure may further comprise a discharge port through which the valuable medium is discharged to outside of the medium processing apparatus. In a case where the valuable medium having been recognized as the check is temporarily stored in the temporary storage and then the transaction involving the check is not approved by the external apparatus, the controller may perform control such that the valuable medium having been stored in the temporary storage is discharged through the discharge port.

With such a configuration, in a case where a check with which no transaction can be performed has been received, it is possible to quickly discharge the check.

In the medium processing apparatus according to an aspect of the present disclosure, in a case where the external storage is fully filled, the controller may perform control such that the valuable medium having been received by the medium processing apparatus is stored in the internal storage.

With such a configuration, in a case where the external storage is fully filled, it is possible to avoid a situation in which no valuable medium can be stored.

The medium processing apparatus according to an aspect of the present disclosure further comprises a notification unit. In a case where the external storage is fully filled, the controller may perform control the notification unit such that the notification unit notifies that the external storage is fully filled.

With such a configuration, it is possible to cause a notified person to take measures in response to the external storage being fully filled.

In the medium processing apparatus according to an aspect of the present disclosure, the recognition circuitry may recognize whether the valuable medium is an on-us check issued by a bank at which the medium processing apparatus is installed. The controller may perform control such that the valuable medium having been recognized as the on-us check is stored in the external storage and the valuable medium having been recognized not as the on-us check is stored in the internal storage.

With such a configuration, it is possible to change the storage destination for a check based on whether the check is an on-us check issued by a bank at which the own apparatus is installed. The value of a check is not lost until a transaction is completed, and for a check that is not an on-us check, a transaction involving an external apparatus may take time. By storing a check, which is not an on-us check, in the internal storage, it is easier to secure the time until a transaction is completed.

The medium processing apparatus according to an aspect of the present disclosure may further comprise a holder that is provided in a housing comprising at least the safe and holds the external storage such that the external storage is attachable to and detachable from an outer side of the housing.

Such a configuration allows the external storage to be detached from the medium processing apparatus.

The medium processing apparatus according to an aspect of the present disclosure may further comprise a reception port through which the valuable medium is received. At a facility at which the medium processing apparatus is installed, one side of the housing may be disposed on one side of a wall of the facility so as to be exposed, another side of the housing may be disposed on another side of the wall so as to be exposed, the reception port may be provided on the one side of the housing, and the holder may be provided on the other side of the housing.

In a case where the medium processing apparatus is, for example, an automated teller machine (ATM) of a bank, the medium processing apparatus may be disposed in a state of being fitted into a hole provided in a wall of the bank. In this case, among the surfaces that the medium processing apparatus comprises, the surface at which a customer operates the medium processing apparatus is disposed on the front side of a wall surface of the bank, and the surface on the side opposite to the front side is disposed on the rear side of the wall surface. Thus, for example, a bank clerk can operate the medium processing apparatus regardless of whether a customer is using the medium processing apparatus.

In the medium processing apparatus according to an aspect of the present disclosure, the holder may comprise a lock that regulates detachment of the external storage that has been attached.

Such a configuration makes it possible to enhance the security of the external storage.

In the medium processing apparatus according to an aspect of the present disclosure, the controller may perform control such that the valuable medium having been recognized as the banknote is stored in the internal storage.

Such a configuration makes it possible to store a banknote comprising value as a valuable medium in the internal storage with a high security in comparison with the external storage regardless of a processing state.

The medium processing apparatus according to an aspect of the present disclosure may further comprise a conveyor that conveys the valuable medium having been received such that a long edge orientation of the valuable medium and a conveyance direction of the valuable medium become parallel.

Such a configuration makes it possible to perform processing on checks with various sizes in the long edge orientation.

A storage method according to an aspect of the present disclosure is a storage method of a medium processing apparatus that receives a valuable medium comprising a check and a banknote, and stores the valuable medium in an internal storage, which is disposed inside a safe, or an external storage, which is disposed outside the safe. The storage method comprises: recognizing the valuable medium having been received; and storing the valuable medium in the external storage in a case where the valuable medium has been recognized as the check.

With such a configuration, the medium processing apparatus capable of handling a check and a banknote can store a check in the external storage.

Hereinafter, each embodiment of the present disclosure will be described with reference to the accompanying drawings.

### Entire Configuration of Medium Processing Apparatus

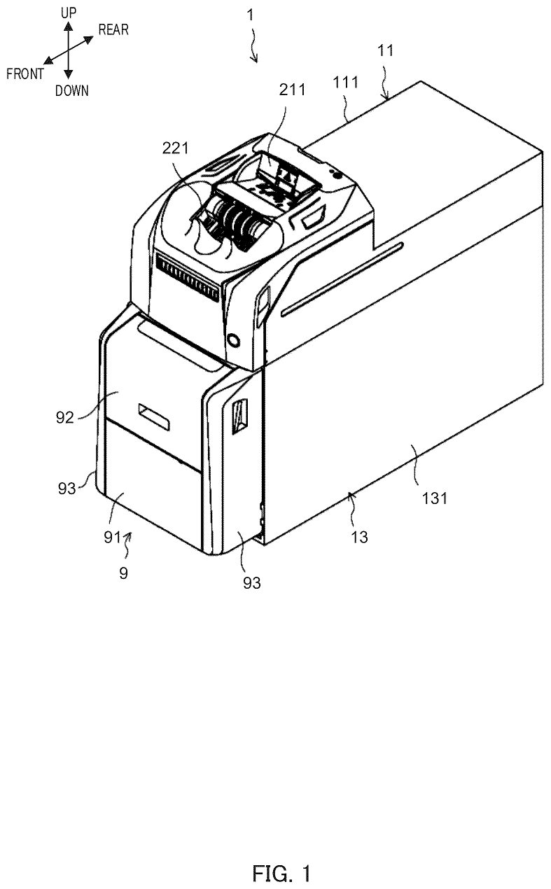

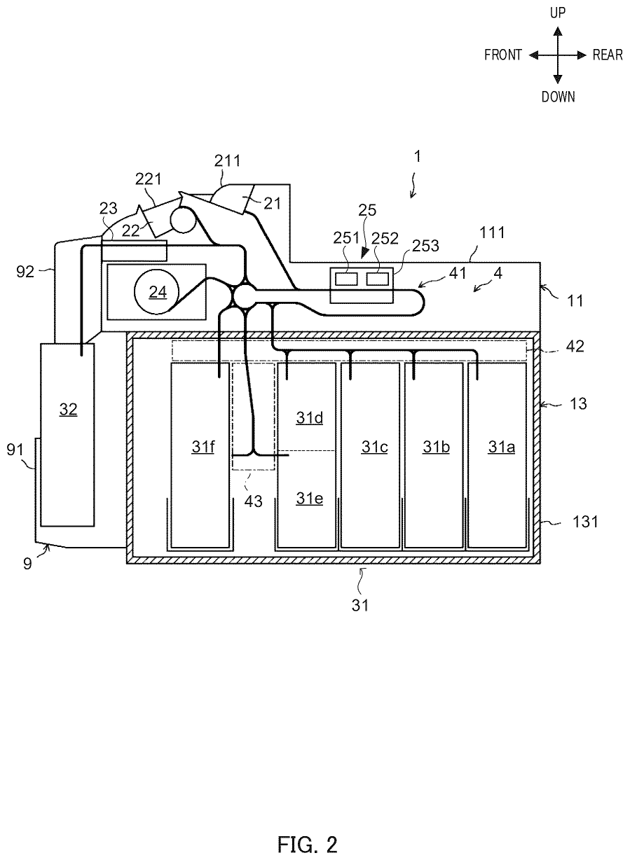

FIG. 1 is an external perspective view of the medium processing apparatus 1. FIG. 2 is a schematic cross-sectional view of the medium processing apparatus 1 in a front-rear direction. FIG. 2 illustrates the internal structure of the medium processing apparatus 1. The medium processing apparatus 1 comprises a processing unit 11 in an upper portion and the safe 13 in a lower portion. Note that, media that are handled by the medium processing apparatus 1 are valuable media. As examples of the valuable media, it is possible to mention banknotes such as bank-issued notes, and securities such as stock certificates, various negotiable or marketable securities, bills of exchange, and checks. The medium processing apparatus 1 to be described below is capable of handling at least banknotes and checks as valuable media.

In the following description related to FIGS. 1 and 2, it is assumed that the side of the medium processing apparatus 1, on which an attachment unit 9 that holds an external cassette 32 to be described is disposed, is the front side of the medium processing apparatus 1, and the side opposite to the front side is the rear side of the medium processing apparatus 1. A reception unit 21 is provided on the front side of the medium processing apparatus 1. Further, it is assumed that the upper and lower sides of the medium processing apparatus 1 correspond to the upper and lower sides of the medium processing apparatus 1, respectively, in a case where the medium processing apparatus 1 is installed on the floor surface in the normal usage aspect.

The processing unit 11 is constituted by an upper housing 111. In the upper housing 111, the reception unit 21, a discharge unit 22, a first conveyor 23, a temporary storage 24, a recognition circuitry 25, and an upper-side conveyance path 41 are disposed. The upper-side conveyance path 41 is a part of a conveyor 4.

The safe 13 is constituted by a safe housing 131. In the safe housing 131, a plurality of storages 31, a lower-side conveyance path 42, and a second lower-side conveyance path 43 are disposed. The plurality of storages 31 disposed inside the safe housing 131 is an example of the internal storage of the present disclosure. The lower-side conveyance path 42 and the second lower-side conveyance path 43 are a part of the conveyor 4.

The safe housing 131 is, for example, a box-shaped housing formed of a metal plate with a predetermined plate thickness. The safe housing 131 is constituted based on a predetermined standard. The safe housing 131 protects the plurality of storages 31 with a predetermined security level or higher. The plurality of storages 31 may be cassettes detachable from the safe housing 131. Each of the plurality of storages 31 may comprise the same configuration. For example, at least one of the plurality of storages 31 may be, for example, a stacking-type storage that stores valuable media in a stacking manner. At least one of the plurality of storages 31 may be a tape-type storage.

In the example illustrated in FIG. 2, a storage 31a, a storage 31b, a storage 31c, a storage 31d, a storage 31e, and a storage 31f are provided as the plurality of storages 31. The medium processing apparatus 1 preliminarily receives storage settings as to in which storage (one of the storages 31a to 31f or the external cassette 32) a predetermined medium is stored. Setting information on the storage settings may be stored in a memory 27 in advance. The medium processing apparatus 1 conveys a received medium to one of the storages 31a to 31f or the external cassette 32 based on the setting information.

The storage settings may be set in advance by, for example, the manager of the medium processing apparatus 1 or the like. As examples of the storage settings, it is possible to mention the following settings. That is, the storage settings comprise storage of a check in the external cassette 32. The storage settings comprise storage of banknotes $1, $5, $10, $20, and $50 in the storages 31a, 31b, 31c, 31d, and 31e, respectively. The storage settings comprise storage of a banknote $100 in the storage 31f, and storage of a check in the storage 31f in a case where the external cassette 32 becomes full with checks. The storage settings may comprise storage of a banknote, which should be stored in the storages 31a to 31e, in the storage 31f in a case where the storages 31a to 31e becomes full.

Each of the plurality of storages 31 comprises a conveyance mechanism. The conveyance mechanism is connected to the lower-side conveyance path 42 or the second lower-side conveyance path 43. The conveyance mechanism causes a valuable medium to be stored in the plurality of storages 31 from the lower-side conveyance path 42 or the second lower-side conveyance path 43, or causes a valuable medium to be fed out from the plurality of storages 31 to the lower-side conveyance path 42 or the second lower-side conveyance path 43.

The medium processing apparatus 1 comprises the attachment unit 9 to which and from which the external cassette 32 is attachable and detachable. The attachment unit 9 holds the external cassette 32 outside the safe 13. The external cassette 32 is an example of the external storage of the present disclosure. The external cassette 32 may also be referred to as a secure transfer cassette (STC) or the like.

The medium processing apparatus 1 is capable of storing a valuable medium not only in the storages 31 disposed inside the safe 13, but also in the external cassette 32 disposed outside the safe 13.

The reception unit 21 is a portion at which the medium processing apparatus 1 receives an input of a valuable medium. The reception unit 21 comprises a reception port 211. The reception port 211 opens upward, for example, in a front part of the upper housing 111. The user of the medium processing apparatus 1 inputs a valuable medium into the reception unit 21 through the reception port 211. Note that, the user in the present embodiment is a person who inputs a valuable medium into the medium processing apparatus 1 and executes an operation to cause the medium processing apparatus 1 to perform processing on the valuable medium, or a person who executes an operation to cause the medium processing apparatus 1 to discharge a valuable medium.

The reception unit 21 holds one valuable medium or a plurality of valuable media in a stacked state. The reception unit 21 comprises a mechanism for taking in valuable media into the medium processing apparatus 1 one by one.

The discharge unit 22 is a portion to which a valuable medium fed out from the storages 31 or the external cassette 32 is conveyed, for example, during withdrawal processing. The discharge unit 22 is capable of holding one valuable medium or a plurality of valuable media in a stacked state. The discharge unit 22 comprises a discharge port 221. The discharge port 221 opens upward, for example, on the front side of the reception port 211 of the upper housing 111. The user can take out banknotes stacked at the discharge unit 22 through the discharge port 221. Note that, the discharge port 221 may comprise a shutter that opens and closes.

The first conveyor 23 conveys a valuable medium inside the medium processing apparatus 1 to the external cassette 32 via the attachment unit 9. Further, the first conveyor 23 conveys a valuable medium fed out from the external cassette 32 into the medium processing apparatus 1. In more detail, the first conveyor 23 connects a conveyance path inside the attachment unit 9 and the upper-side conveyance path 41 inside the upper housing 111.

The temporary storage 24 temporarily stores a valuable medium before being stored in the storages 31 or the external cassette 32 or a valuable medium fed out from the storages 31 or the external cassette 32. The temporary storage 24 is disposed, for example, on the lower side of the first conveyor 23. The temporary storage 24 is, for example, a tape-type storage unit. The temporary storage 24 stores a valuable medium by winding the valuable medium along with a tape around a drum. For this reason, when the temporary storage 24 stores a valuable medium and when the temporary storage 24 feeds out a valuable medium, it is possible to obtain an effect that the order of valuable media does not change. Further, the temporary storage 24 is capable of storing valuable media with various sizes in a mixed state.

The recognition circuitry 25 is disposed in a part of the upper-side conveyance path 41. The recognition circuitry 25 acquires recognition information for recognizing a valuable medium that is conveyed along the upper-side conveyance path 41 and recognizes the valuable medium based on the recognition information. The recognition information comprises an image of a valuable medium and magnetic information read from the valuable medium.

The recognition circuitry 25 comprises an image sensor 251 and a magnetic sensor 252. The image sensor 251 acquires, for example, an image of the front surface of a valuable medium. The magnetic sensor 252 acquires, for example, magnetic information based on magnetic ink printed on the front surface of a valuable medium. As an example of the magnetic information that a valuable medium comprises, it is possible to mention magnetic ink character recognition (MICR) information which is magnetic information of a character(s) printed on the front surface of a check, by using magnetic ink. Although FIG. 2 illustrates an example in which the magnetic sensor 252 is inside a housing 253 of the recognition circuitry 25, the magnetic sensor may be provided outside the sensor housing of the recognition circuitry in the present disclosure.

The conveyor 4 conveys a plurality of valuable media one by one at intervals inside the medium processing apparatus 1. The conveyor 4 is constituted by, for example, a combination of numerous rollers, a plurality of belts, motors for driving those described above, and a plurality of guides. The conveyor 4 conveys, for example, a valuable medium of a rectangular shape with the short edge facing forward. The conveyor 4 may convey a valuable medium with the long edge facing forward.

The conveyor 4 comprises the upper-side conveyance path 41, the lower-side conveyance path 42, and the second lower-side conveyance path 43. The upper-side conveyance path 41 is disposed within the upper housing 111 as described above. The lower-side conveyance path 42 and the second lower-side conveyance path 43 are disposed within the safe housing 131. Note that, at least one conveyance path is disposed between the processing unit 11 and the safe housing 131 to pass through walls of the processing unit 11 and the safe housing 131 in an up-down direction. Thus, the upper-side conveyance path 41 and the lower-side conveyance path 42 are connected to each other.

The upper-side conveyance path 41 is constituted in a loop shape. Separate conveyance paths are disposed between the upper-side conveyance path 41, and the reception unit 21, the discharge unit 22, the first conveyor 23, and the temporary storage 24.

A valuable medium is conveyed in a circulating manner along the upper-side conveyance path 41 in the clockwise direction or in the counterclockwise direction in FIG. 2.

The lower-side conveyance path 42 is disposed above the plurality of storages 31. The lower-side conveyance path 42 is disposed to spread in the front-rear direction. Separate conveyance paths are disposed between the lower-side conveyance path 42 and the plurality of storages 31.

The second lower-side conveyance path 43 is disposed so as to extend downward from the lower-side conveyance path 42. In the example illustrated in FIG. 2, in a case where the storages 31 comprise a structure in which two storages 31 are stacked in the up-down direction, the second lower-side conveyance path 43 connects the storage 31 on the lower side and the lower-side conveyance path 42.

The configuration of the storages in the medium processing apparatus 1 illustrated in FIG. 2 is one example. In the present disclosure, the number of storages to be accommodated within the safe housing, the arrangement of the storages, and the structure of each storage are not limited to the examples illustrated in FIG. 2.

Tracking sensors configured to detect the passage of a valuable medium, timing sensors configured to detect an edge of a valuable medium, and/or the like may be disposed at various points of the upper-side conveyance path 41, the lower-side conveyance path 42, and the second lower-side conveyance path 43. A controller 15 to be described later controls the conveyor 4 based on detection signals of the tracking and timing sensors such that a valuable medium is conveyed to a desired conveyance destination via the upper-side conveyance path 41, the lower-side conveyance path 42, and the second lower-side conveyance path 43.

The attachment unit 9 comprises a holder 91, a second conveyor 92, and side surface units 93.

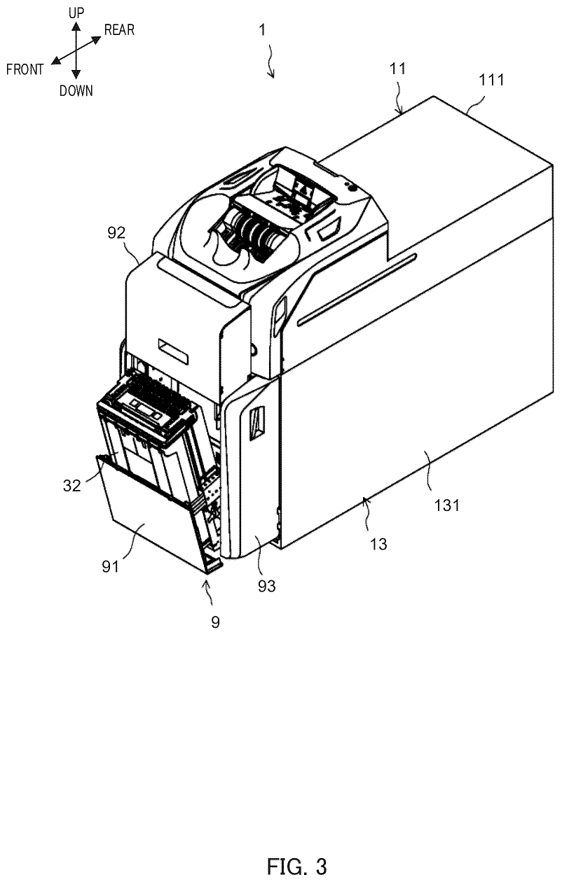

FIG. 3 is an external perspective view of the medium processing apparatus 1 in the same manner as FIG. 1, and illustrates an external appearance of the medium processing apparatus 1 when the external cassette 32 is attached to the attachment unit 9. FIG. 1, on the other hand, illustrates an external appearance of the medium processing apparatus 1 when the external cassette 32 is not attached to the attachment unit 9.

The holder 91 is disposed on the lower side of the attachment unit 9, and the second conveyor 92 is disposed on the upper side of the holder 91. When the external cassette 32 is attached to the attachment unit 9, the upper end of the holder 91 tilts to the front side. In this state, the holder 91 receives the insertion of the external cassette 32 from the upper side. After the insertion of the external cassette 32 is completed, the holder 91 holds the external cassette 32.

The holder 91 may comprise a lock 911 that regulates detachment of the external cassette 32 that has been attached.

The second conveyor 92 is movable in the up-down direction. When the external cassette 32 is attached to the attachment unit 9, the second conveyor 92 is moved to the upper side. This makes it easier to insert the external cassette 32 into the holder 91. The second conveyor 92 is moved up and down, for example, by a hand of the manager of the medium processing apparatus 1 or the like.

Note that, the manager of the medium processing apparatus 1 is, for example, a person who works at a facility at which the medium processing apparatus 1 is installed, and who comprises predetermined authority or higher. The manager and the user may be different persons or may be the same person. In a case where the medium processing apparatus 1 is installed at a bank, the manager is, for example, a bank clerk. In a case where the medium processing apparatus 1 is installed at a store, the manager is, for example, the store manager or a division manager.

The side surface units 93 support the holder 91 and the second conveyor 92, for example, from both sides. The side surface units 93 support the holder 91 such that the holder 91 is tiltable frontward. Further, the side surface units 93 support the second conveyor 92 such that the second conveyor 92 is movable in the up-down direction.

The second conveyor 92 is connected to the first conveyor 23. The second conveyor 92 comprises a conveyance path inside. The conveyance path of the second conveyor 92 is connected to the upper-side conveyance path 41 via the first conveyor 23. The second conveyor 92 conveys a valuable medium fed out from the external cassette 32 to the first conveyor 23. The second conveyor 92 stores a valuable medium, which has been conveyed from the first conveyor 23, in the external cassette 32.

The external cassette 32 is a portable-type storage. The external cassette 32 is, for example, a stacking-type storage. The external cassette 32 comprises a fullness detection sensor 321 configured to detect whether valuable media stored therein are fully filled.

### Functional Configuration of the Medium Processing Apparatus 1

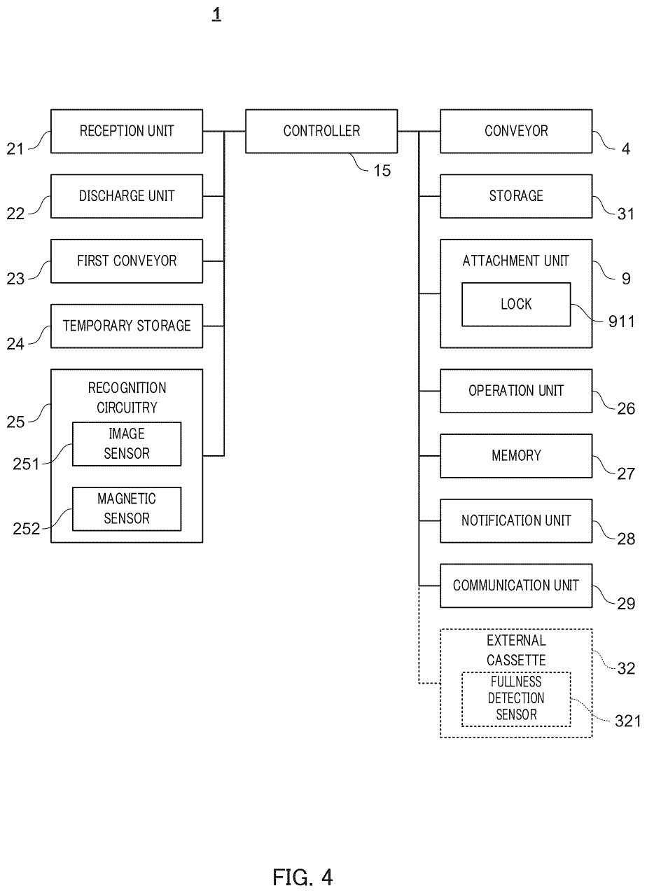

FIG. 4 is a functional block diagram provided for describing a functional configuration of the medium processing apparatus 1. As illustrated in FIG. 4, the medium processing apparatus 1 comprises the controller 15. The controller 15 is constituted by a processor such as, for example, a central processing unit (CPU). That is, the medium processing apparatus 1 comprising the controller 15 is an example of a computer comprising a processor.

The reception unit 21, the discharge unit 22, the first conveyor 23, the temporary storage 24, the recognition circuitry 25, the conveyor 4, the storages 31, and the attachment unit 9 are connected to the controller 15 in a communicable manner. The recognition circuitry 25 comprises the image sensor 251 and the magnetic sensor 252. The attachment unit 9 comprises the lock 911. In a case where the external cassette 32 is attached to the attachment unit 9, the external cassette 32, and the fullness detection sensor 321, which the external cassette 32 comprises, may be further connected to the controller 15 in a communicable manner.

The medium processing apparatus 1 comprises an operation unit 26 configured to receive an operation of the user or the manager, the memory 27 configured to store various kinds of data and the like, a notification unit 28 configured to perform various kinds of notifications, and a communication unit 29 configured to communicate with an external apparatus of the medium processing apparatus 1. The operation unit 26 is, for example, a various kinds of operation devices such as a keyboard, a button, a switch, a trackball, and a touch pad. The notification unit 28 may be a display device, such as a display, for example. The notification unit 28 may be a sound generation device such as a speaker. The notification unit 28 may comprise an illumination device such as a light emitting diode (LED).

The operation unit 26, the memory 27, the notification unit 28, and the communication unit 29 are connected to the controller 15 in a communicable manner.

The controller 15 causes various processing to be executed in response to operations on the operation unit 26 by the user or the manager. In more detail, the controller 15 controls the reception unit 21, the discharge unit 22, the first conveyor 23, the temporary storage 24, the recognition circuitry 25, the conveyor 4, the storages 31, the attachment unit 9, the notification unit 28, and the communication unit 29 according to operation contents.

### Operation Examples

Hereinafter, operations of the medium processing apparatus 1 when executing various processing will be described.

### Reception Processing: First Example

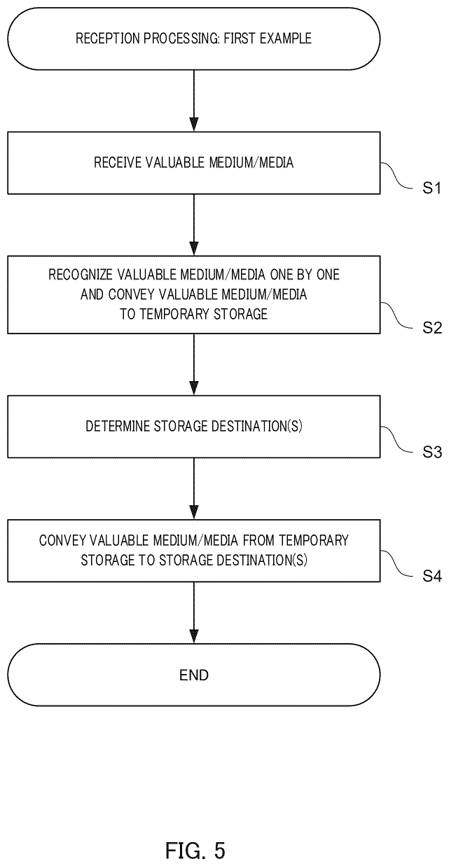

FIG. 5 is a flowchart provided for describing a first example of reception processing of the medium processing apparatus 1. The reception processing is processing in which the medium processing apparatus 1 stores a valuable medium, which is inputted by the user, in the storages 31 or the external cassette 32.

In step S1, the controller 15 controls the reception unit 21 such that the reception unit 21 receives a valuable medium/valuable media to be inputted, which is/are inputted through the reception port 211 by the user, one by one. The valuable medium/media received by the reception unit 21 is/are conveyed to the recognition circuitry 25 one by one by the conveyor 4.

In step S2, the recognition circuitry 25 recognizes the received valuable medium/media one by one. More specifically, the recognition circuitry 25 acquires recognition information comprising images and magnetic information of valuable media from a valuable medium to be recognized, and recognizes the valuable medium based on the recognition information.

The recognition of a valuable medium by the recognition circuitry 25 comprises recognition of whether a valuable medium to be recognized is a banknote or a check. As an example, the recognition of whether a valuable medium to be recognized is a banknote or a check may be performed based on the shape and size of the valuable medium on the basis of an image, MICR information comprised in the magnetic information, and/or the like.

The recognition of a valuable medium by the recognition circuitry 25 may also comprise recognition of the authentication, denomination, and fitness of a valuable medium which has been recognized as a banknote. The recognition of a valuable medium by the recognition circuitry 25 may also comprise recognition of the face value of a valuable medium which has been recognized as a check. As an example, the recognition circuitry 25 may execute optical character recognition (OCR) processing on an image of the front surface of a valuable medium, which has been recognized as a check, to recognize the face value described on the front surface, for example.

The valuable medium/media recognized by the recognition circuitry 25 is/are conveyed to the temporary storage 24 by the conveyor 4 and is/are temporarily stored in the temporary storage 24.

In step S3, the controller 15 determines the (respective) storage destination(s) for the valuable medium/media received in step S1. The determination of the storage destination(s) may be performed based on the recognition result(s) in step S2 and storage settings set in advance according to the kind(s) of the medium/media specified by the recognition result(s).

In a case where an inputted valuable medium is a banknote, the controller 15 determines, as the storage destination for the valuable medium, one of the storages 31 (31a to 31e) which are the storages inside the safe 13, based on the storage settings. In a case where a valuable medium is a banknote, a different storage among the plurality of storages 31 may be determined as the storage destination for each denomination.

In a case where an inputted valuable medium is a check, the controller 15 determines, as the storage destination for the valuable medium, the external cassette 32 which is the storage outside the safe 13, based on the storage settings. In a case where an inputted valuable medium is a check and in a case where the fullness detection sensor 321 detects that the external cassette 32 is fully filled, the controller 15 may determine, as the storage destination for the valuable medium, the storages 31 based on the storage settings. In this case, the storage destination for the check may be determined to be, among the plurality of storages 31, a specific storage 31 prepared for storing checks.

In a case where it has been detected that the external cassette 32 is fully filled, the controller 15 may control the notification unit 28 such that the notification unit 28 notifies that the external cassette 32 is fully filled.

In a case where it has not been detected that the external cassette 32 is fully filled, the controller 15 may determine the external cassette 32 as the storage destination for a valuable medium, and after the number of sheets of the valuable medium, for which the external cassette 32 is determined as the storage destination, exceeds the remaining number of sheets that can be stored in the external cassette 32 (the number of sheets that can be stored before the external cassette 32 becomes fully filled), the controller 15 may determine the storages 31 as the storage destination for the valuable medium.

Unlike a banknote, a check whose check information has been read is not reutilized, and is therefore stored in the external cassette 32 with a lower security level than the storages 31.

In a case where a valuable medium is a banknote, it is possible to protect the banknote, which itself comprises value, with a relatively high security level by storing the banknote in the storages 31 disposed inside the safe 13.

In comparison with the storages 31 disposed inside the safe 13, the external cassette 32 that is attached to the attachment unit 9 comprises an advantage that it is easier for the manager to collect a stored valuable medium. As described above, by configuring the external cassette 32 as the storage destination for a check in the medium processing apparatus 1 configured to handle a check and a banknote, it is possible to significantly reduce the labor of the manager when collecting a check.

In addition, by storing a banknote and a check in storages with different security levels, respectively, it is possible to prevent, for example, a situation in which the storages 31 with a relatively high security level are likely to become fully filled. Thus, it is possible to prevent a situation in which, by storing a check in the storages 31 with a relatively high security level, a banknote that should be stored in the storages 31 cannot be stored therein.

In step S4, the controller 15 controls the conveyor 4 such that the conveyor 4 conveys each valuable medium, which has been temporarily stored in the temporary storage 24, to each storage destination. Each storage destination stores the conveyed valuable medium. In a case where a plurality of valuable media has been received in step S1, every valuable medium present at the reception port 211 is conveyed to the temporary storage 24, the conveyance destinations are determined (steps S2 and S3), and then the respective media are conveyed to the predetermined conveyance destinations (step S4). When the processing in steps S2 to S4 for every valuable medium is completed, the controller 15 causes the memory 27 to store information on the kinds of valuable media, which have been stored in the storages 31 or the external cassette 32, respectively, and the number of sheets of the valuable media. Thus, the reception processing is completed.

Note that, the controller 15 may control the notification unit 28, at a time point when the recognition of every inputted valuable medium is completed, such that the notification unit 28 notifies the user of the total money amount of every inputted valuable medium. Then, the controller 15 may receive an acceptance operation for the user to accept the reception processing or a non-acceptance operation for the user not to accept the reception processing, via the operation unit 26. In a case where the controller 15 receives an acceptance operation via the operation unit 26, the controller 15 may complete the reception processing. In a case where the controller 15 receives a non-acceptance operation via the operation unit 26, the controller 15 may control the conveyor 4 such that the conveyor 4 conveys every valuable medium stored in the temporary storage 24 to the discharge unit 22 and the every valuable medium is returned to the user.

### Reception Processing: Second Example

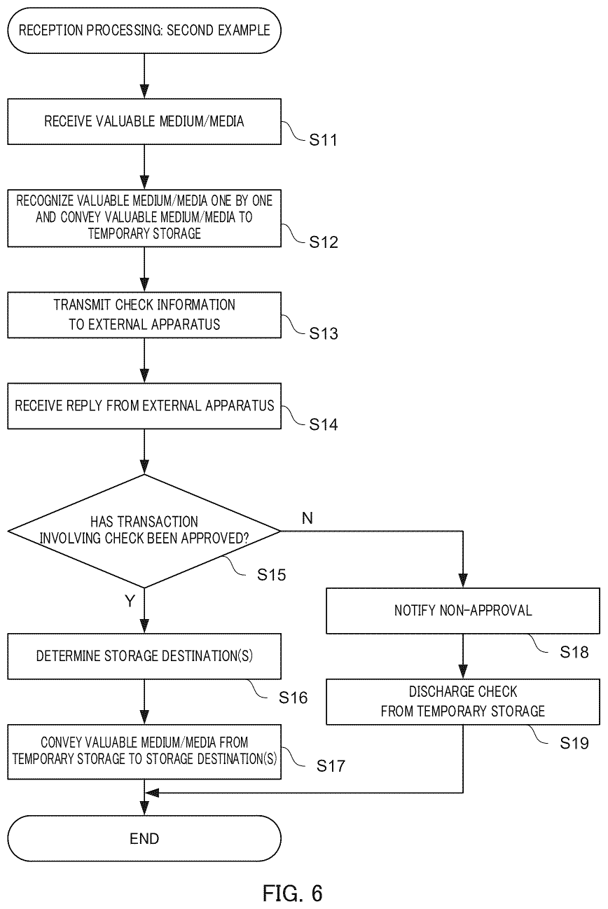

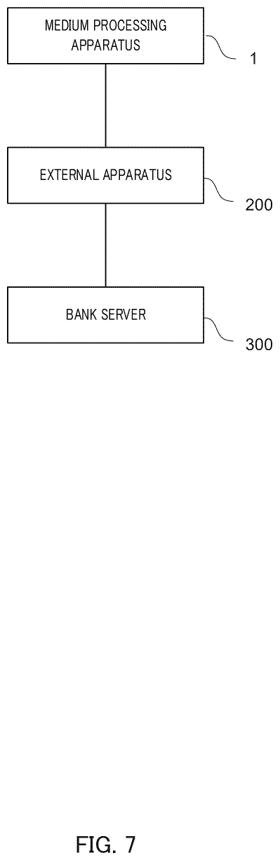

Hereinafter, a second example of the reception processing will be described. FIG. 6 is a flowchart provided for describing a second example of the reception processing of the medium processing apparatus 1. The second example of the reception processing is an example in which an apparatus that an external small amount payment service comprises (an external apparatus 200) approves a transaction involving a valuable medium. FIG. 7 illustrates a relationship between the medium processing apparatus 1 and the external apparatus 200 in the second example of the reception processing.

In step S11, the controller 15 controls the reception unit 21 such that the reception unit 21 receives a valuable medium/valuable media to be inputted, which is/are inputted through the reception port 211 by the user, one by one. The valuable medium/media received by the reception unit 21 is/are conveyed to the recognition circuitry 25 one by one by the conveyor 4.

In step S12, the recognition circuitry 25 recognizes the received valuable medium/media one by one. More specifically, the recognition circuitry 25 acquires recognition information comprising images and magnetic information of valuable media from a valuable medium to be recognized, and recognizes the valuable medium based on the recognition information.

The recognition of a valuable medium by the recognition circuitry 25 comprises recognition of whether a valuable medium to be recognized is a banknote or a check. In a case where a valuable medium to be recognized is a check, the recognition of a valuable medium by the controller 15 may comprise recognition of whether the check is a check issued by a bank at which the medium processing apparatus 1 is installed. In the following description, a check issued by a bank (own bank) at which the medium processing apparatus 1 is installed will be referred to as an on-us check, and a check issued by a bank (other bank), which is not the bank at which the medium processing apparatus 1 is installed, will be referred to as an off-us check.

The valuable medium/media whose recognition recognized by the recognition circuitry 25 is/are conveyed to the temporary storage 24 by the conveyor 4 and is/are temporarily stored in the temporary storage 24.

In a case where a valuable medium has been recognized as a check, the controller 15 controls the communication unit 29 in step S13 such that the communication unit 29 transmits check information comprising an image and MICR information of the check to the external apparatus 200 of the external small amount payment service in order to obtain an approval for a transaction involving the check by an external facility. The external service is a small amount payment service, such as FedACH or TCH in the United States, which deals with transactions involving checks. FedACH is an automated clearing house (ACH) service operated by the Federal Reserve Banks. TCH is a service operated by The Clearing House that is a private company.

The external apparatus 200 of the small amount payment service is a server capable of communicating with the medium processing apparatus 1 via a public network such as the Internet. The server comprises a CPU, and the CPU executes processing that is performed by the external apparatus (server) 200. The external apparatus 200 of the small amount payment service makes an inquiry to a bank server 300, which a bank that has issued the check comprises, about whether a transaction involving the check may be executed, based on the check information received from the medium processing apparatus 1. The external apparatus 200 may be connected to the bank server 300 in a communicable manner via a public network such as the Internet.

The bank server 300 that has received the inquiry returns, to the external apparatus 200, information on whether the transaction involving the check may be performed, for example, based on the face value of the check, the balance of the account of the drawer, and/or the like. In a case where the external apparatus 200 has received, from the bank server 300, information indicating that the transaction involving the check may be performed, the external apparatus 200 transmits, to the medium processing apparatus 1, approval information indicating that the transaction involving the check has been approved. In a case where the external apparatus 200 has received, from the bank server 300, information indicating that the transaction involving the check is not allowed to be performed, on the other hand, the external apparatus 200 transmits, to the medium processing apparatus 1, non-approval information indicating that the transaction involving the check has not been approved. The small amount payment service is known in the art and therefore a detailed description thereof will be omitted.

In step S14, the controller 15 receives approval information or non-approval information from the external apparatus 200 via the communication unit 29.

In step S15, the controller 15 determines whether the transaction involving the check has been approved by the external apparatus 200. In a case where the transaction involving the check has been approved (step S15: YES), in other words, in a case where the controller 15 has received approval information from the external apparatus 200 in step S14, the controller 15 advances the reception processing to step S16. In a case where the transaction involving the check has not been approved (step S15: NO), in other words, in a case where the controller 15 has received non-approval information from the external apparatus 200 in step S14, the controller 15 advances the reception processing to step S18.

In step S16, the controller 15 determines the (respective) storage destination(s) for the valuable medium/media received in step S11. The determination of the storage destination(s) may be performed based on the recognition result(s) in step S12 and the approval information or non-approval information received from the external apparatus 200 in step S14.

In a case where an inputted valuable medium is a banknote, the controller 15 determines, as the storage destination for the valuable medium, one of the storages 31 which are the storages inside the safe 13. In a case where a valuable medium is a banknote, a different storage among the plurality of storages 31 may be determined as the storage destination for each denomination. The conveyance destination for a medium is determined based on an image of the medium acquired by the image sensor 251 and the setting information stored in the memory 27.

In a case where an inputted valuable medium is a check, the controller 15 determines, as the storage destination for the valuable medium, the external cassette 32 which is the storage outside the safe 13, based on the setting information. In a case where an inputted valuable medium is a check and in a case where the fullness detection sensor 321 detects that the external cassette 32 is fully filled, the controller 15 changes the storage destination for the check from the external cassette 32 to the storage 31f inside the safe 13, based on the setting information. Thereafter, when checks have been removed from the external cassette 32 by the manager and the state in which the external cassette 32 is fully filled has been cleared, the controller 15 changes the storage destination for a check from the storage 31f to the external cassette 32, based on the setting information.

At this time, in a case where the state in which the external cassette 32 is fully filled has been cleared, the controller 15 may perform control such that a check, which has been stored in the storage 31f while the external cassette 32 is fully filled, is conveyed to the external cassette 32 after the state in which the external cassette 32 is fully filled has been cleared. With such a configuration, even when the manager collects a check that has been temporarily stored in the storage 31f while the external cassette 32 is fully filled, it is unnecessary to open the safe 13 to take out a check from the storages 31 inside the safe 13.

In a case where it has been detected that the external cassette 32 is fully filled, the controller 15 may control the notification unit 28 such that the notification unit 28 notifies that the external cassette 32 is fully filled.

In a case where it has not been detected that the external cassette 32 is fully filled, the controller 15 may determine the external cassette 32 as the storage destination for a valuable medium, and after the number of sheets of the valuable medium, for which the external cassette 32 is determined as the storage destination, exceeds the remaining number of sheets that can be stored in the external cassette 32 (the number of sheets that can be stored before the external cassette 32 becomes fully filled), the controller 15 may determine the storages 31 as the storage destination for the valuable medium.

Further, the controller 15 may determine a storage destination based on whether an inputted valuable medium is an on-us check. Specifically, in a case where an inputted valuable medium is an on-us check, the controller 15 may determine the external cassette 32 as the storage destination for the check. In a case where an inputted valuable medium is an off-us check, on the other hand, the controller 15 may determine the storage 31f as the storage destination for the check.

With such a method of determining a storage destination, the following effect can be achieved. In a case where a valuable medium is a banknote, it is possible to protect the banknote, which itself comprises value, with a relatively high security level by storing the banknote in the storages 31 disposed inside the safe 13.

In a case where a valuable medium is a check, on the other hand, it is considered that the check itself comprises no value after a transaction involving the check has been approved. For this reason, a check for which approval information on the check has been received from the external apparatus 200 may be stored in the external cassette 32 with a lower security level than the storages 31.

In comparison with the storages 31 disposed inside the safe 13, the external cassette 32 that is attached to the attachment unit 9 comprises an advantage that it is easier for the manager to collect a stored valuable medium. As described above, by configuring the external cassette 32 as the storage destination for a check in the medium processing apparatus 1 configured to handle a check and a banknote, it is possible to significantly reduce the labor of the manager when collecting a check.

In addition, by storing a banknote and a check in storages with different security levels, respectively, it is possible to prevent, for example, a situation in which the storages 31 with a relatively high security level are likely to become fully filled. Thus, it is possible to prevent a situation in which, by storing a check in the storages 31 with a relatively high security level, a banknote that should be stored in the storages 31 cannot be stored therein.

When the external cassette 32 is configured as the storage destination for an on-us check and the storages 31 is configured as the storage destination for an off-us check, it is possible for the manager, for example, in a case where there is an inquiry about an off-us check from another bank thereafter, to surely arrive at the off-us check corresponding to the inquiry. Such an effect is not achievable in a case where an off-us check is stored in the external cassette 32 since the security of the external cassette 32 is lower than that of the storages 31 and the external cassette 32 is detachable from the medium processing apparatus 1.

In step S17, the controller 15 controls the conveyor 4 such that the conveyor 4 conveys each valuable medium, which has been temporarily stored in the temporary storage 24, to each storage destination. Each storage destination stores the conveyed valuable medium. The controller 15 causes the memory 27 to store information on the kinds of valuable media, which have been stored in the storages 31 or the external cassette 32, respectively, and the number of sheets of the valuable media. Thus, the reception processing is completed. In the same manner as in the first example, the total money amount of inputted valuable medium/media may be notified to the user and an acceptance operation via the operation unit 26 may be received.

In step S18, the controller 15 controls the notification unit 28 such that the notification unit 28 notifies the user that an approval for the transaction involving the check has not been obtained.

In step S19, the controller 15 controls the temporary storage 24 and the conveyor 4 such that the conveyor 4 conveys the check, for which an approval for the transaction has not been obtained, from the temporary storage 24 to the discharge unit 22. Thus, it is possible to return the check, for which an approval for the transaction has not been obtained, to the user.

In a case where a plurality of valuable media has been received in step S11, the processing in steps S12 to S19 is executed on each valuable medium. In a case where a plurality of valuable media has been received in step S11, every valuable medium present at the reception port 211 is conveyed to the temporary storage 24 (step S12), and it is then determined based on the approval information or non-approval information received from the external apparatus 200 how the media are handles (step S15). Further, after step S15, the processing in steps S16 and S17 or the processing in steps S18 and S19 is executed on each medium stored in the temporary storage 24.

In a case where there is a plurality of checks stored in the temporary storage 24, the approval result by the external apparatus 200 may differ for each check in step S15. In such a case, the processing in steps S16 and S17 or the processing in steps S18 and S19 may be executed as appropriate for each check to be discharged from the temporary storage 24.

When the processing in steps S12 to S19 for every valuable medium is completed, the controller 15 causes the memory 27 to store information on the kinds of valuable media, which have been stored in the storages 31 or the external cassette 32, respectively, and the number of sheets of the valuable media. Thus, the reception processing is completed. In the same manner as in the first example of the reception processing, the controller 15 may perform a notification of the total money amount of every valuable medium.

Note that, in a case where a received valuable medium/received valuable media is/are a banknote(s) in the second example of the reception processing illustrated in FIG. 6, the processing in steps S13 to S19 is not executed. In a case where received valuable medium/media is/are a banknote(s), the storage destination(s) for each banknote is/are determined based on the recognition result(s) in step S12 and the setting information stored in the memory 27, and each banknote is conveyed to the determined storage destination(s) and is stored therein.

### Reception Processing: Variations

Hereinafter, variations of the second example of the reception processing described above will be described.

### Variation 1

An approval for a transaction involving a check by the external apparatus 200 may take a certain amount of time or longer. This is because the small amount payment service comprising the external apparatus 200 is required to obtain an answer from the bank server 300 that has issued the check.

In this case, there is some time between when the check information is transmitted to the external apparatus 200 in step S13 in FIG. 6 and when a reply from the external apparatus 200 is received in step S14. In the second example illustrated in FIG. 6, the reception processing cannot be completed unless a reply from the external apparatus 200 can be received, and thus, it may be configured such that the storage destination is determined at a time point when the recognition information on the check is acquired as in the first example illustrated in FIG. 5. Thus, it is possible to advance the reception processing even in a case where there is some time between when the medium processing apparatus 1 transmits the check information to the external apparatus 200 and when the medium processing apparatus 1 receives a reply from the external apparatus 200 of the small amount payment service.

### Variation 2

In the second example of the reception processing illustrated in FIG. 6, a recognized valuable medium is conveyed to the temporary storage 24 and is temporarily stored therein. In the present disclosure, the medium processing apparatus may comprise no temporary storage. In this case, in a case where a recognized valuable medium is a check, the check may continue to be conveyed, for example, on a conveyance path(s) of the conveyor in the reception processing until a transaction involving the check is approved by the external apparatus and the storage destination for the check is determined. Further, the check may also be temporarily stored in any storage capable of feeding out the check until a transaction involving the check is approved by the external apparatus and the storage destination for the check is determined. After the storage destination for the check is determined, the check may be fed out from the storage capable of feeding out the check and may be stored in the determined storage destination. In a case where a recognized valuable medium is a banknote, the storage destination may be immediately determined based on the recognition result and the setting information and the banknote may be stored therein.

### Discharge Processing

Hereinafter, discharge processing of the medium processing apparatus 1 will be described. The controller 15 receives a discharge processing-related operation of the user via the operation unit 26. The discharge processing-related operation of the user is, for example, an operation to designate the total money amount of a banknote(s) to be discharged.

The controller 15 determines, based on a discharge processing-related operation, a denomination(s) of a banknote(s) to be discharged and the number of sheets of the banknote(s) to be discharged. The controller 15 controls the storages 31 such that the storages 31 feed out the determined number of sheets of the banknote(s) of the determined denomination(s) to a conveyance path(s). The controller 15 controls the conveyor 4 such that the conveyor 4 conveys, to the discharge unit 22, the banknote(s) fed out from the storages 31. Thus, the user can receive a banknote(s) via the discharge port 221. The controller 15 deletes information on the banknote(s) fed out from the storages 31 from the memory 27. Thus, the discharge processing is completed.

### Example of Hardware Configuration

In each embodiment described above, it has been described that the controller 15 is a processor formed of electric circuitry and the medium processing apparatus 1 comprising the controller 15 is an example of a computer comprising a processor. Hereinafter, an example of a hardware configuration of a computer that realizes the medium processing apparatus in the present disclosure will be described.

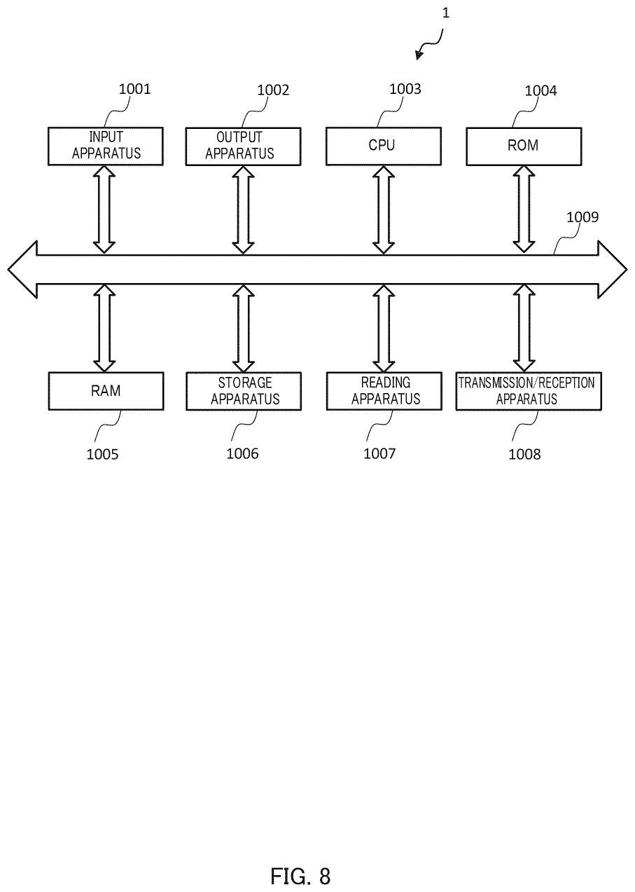

FIG. 8 illustrates an example of a hardware configuration of the medium processing apparatus 1 as a computer.

The medium processing apparatus 1 comprises, as the hardware configuration, an input apparatus 1001, an output apparatus 1002, a CPU 1003, a read only memory (ROM) 1004, a random access memory (RAM) 1005, a storage apparatus 1006, a reading apparatus 1007 for reading information from various kinds of non-transitory computer-readable recording media, and a transmission/reception apparatus 1008, and the respective units are connected by a bus 1009.

The reading apparatus 1007 reads a program for implementing the functions of the medium processing apparatus 1 from a non-transitory computer-readable recording medium that records the program, and causes the storage apparatus 1006 to store the program.

Alternatively, the transmission/reception apparatus 1008 communicates with a system apparatus connected to a network and causes the storage apparatus 1006 to store a program downloaded from the system apparatus.

Then, the CPU 1003 copies the program stored in the storage apparatus 1006 to the RAM 1005, sequentially reads instructions comprised in the program from the RAM 1005, and executes the instructions, thereby implementing the functions of the medium processing apparatus 1.

1. A medium processing apparatus that processes a valuable medium comprising a check and a banknote, the medium processing apparatus comprising:
an internal storage that is disposed inside a safe and stores the valuable medium;
an external storage that is disposed outside the safe and stores the valuable medium;
a recognition circuitry that acquires recognition information from the valuable medium having been received by the medium processing apparatus and recognizes the valuable medium based on the recognition information; and
a controller that performs control such that the valuable medium having been recognized as the check is stored in the external storage.

2. The medium processing apparatus according to claim 1, wherein:
the recognition circuitry comprises an image sensor and a magnetic sensor, the image sensor acquiring an image of the valuable medium, the magnetic sensor acquiring magnetic ink character recognition (MICR) information of the check, the image and the MICR information being the recognition information, and
the controller performs control based on at least one of the image and/or the MICR information such that the check is stored in the external storage, the check being a check for which at least one of the image and/or the MICR information has been acquired.

3. The medium processing apparatus according to claim 2, wherein the controller performs control such that the at least one of the image and/or the MICR information is transmitted to an external apparatus, the at least one of the image and/or the MICR information having been acquired from the check, the external apparatus approving a transaction involving the check.

4. The medium processing apparatus according to claim 3, further comprising a notification unit, wherein
in a case where the transaction involving the check has not been approved by the external apparatus, the controller controls the notification unit such that the notification unit notifies that the transaction has not been approved.

5. The medium processing apparatus according to claim 4, further comprising a temporary storage that temporarily stores the valuable medium having been received by the medium processing apparatus before the valuable medium having been received by the medium processing apparatus is stored in the internal storage or the external storage, wherein
in a case where the valuable medium having been recognized as the check is temporarily stored in the temporary storage and then the transaction involving the check is approved by the external apparatus, the controller performs control such that the valuable medium having been stored in the temporary storage is stored in the external storage.

6. The medium processing apparatus according to claim 5, further comprising a discharge port through which the valuable medium is discharged to outside of the medium processing apparatus, wherein
in a case where the valuable medium having been recognized as the check is temporarily stored in the temporary storage and then the transaction involving the check is not approved by the external apparatus, the controller performs control such that the valuable medium having been stored in the temporary storage is discharged through the discharge port.

7. The medium processing apparatus according to claim 1, wherein in a case where the external storage is fully filled, the controller performs control such that the valuable medium having been received by the medium processing apparatus is stored in the internal storage.

8. The medium processing apparatus according to claim 7, further comprising a notification unit, wherein
in a case where the external storage is fully filled, the controller performs control the notification unit such that the notification unit notifies that the external storage is fully filled.

9. The medium processing apparatus according to claim 1, wherein:
the recognition circuitry recognizes whether the valuable medium is an on-us check or not, the on-us check being a check issued by a bank at which the medium processing apparatus is installed, and
the controller performs control such that the valuable medium having been recognized as the on-us check is stored in the external storage and the valuable medium having been recognized not as the on-us check is stored in the internal storage.

10. The medium processing apparatus according to claim 1, further comprising a holder that is provided in a housing comprising at least the safe and holds the external storage such that the external storage is attachable to and detachable from an outer side of the housing.

11. The medium processing apparatus according to claim 10, further comprising a reception port through which the valuable medium is received, wherein at a facility at which the medium processing apparatus is installed, one side of the housing is disposed on one side of a wall of the facility so as to be exposed, another side of the housing is disposed on another side of the wall so as to be exposed, the reception port is provided on the one side of the housing, and the holder is provided on the other side of the housing.

12. The medium processing apparatus according to claim 11, wherein the holder comprises a lock that regulates detachment of the external storage that has been attached.

13. The medium processing apparatus according to claim 1, wherein the controller performs control such that the valuable medium having been recognized as the banknote is stored in the internal storage.

14. The medium processing apparatus according to claim 1, further comprising a conveyor that conveys the valuable medium having been received such that a long edge orientation of the valuable medium and a conveyance direction of the valuable medium are parallel.

15. A storage method of a medium processing apparatus, the medium processing apparatus receiving a valuable medium comprising a check and a banknote, and storing the valuable medium in an internal storage or an external storage, the internal storage being disposed inside a safe, the external storage being disposed outside the safe, the storage method comprising:
recognizing the valuable medium having been received; and
storing the valuable medium in the external storage in a case where the valuable medium has been recognized as the check.
